(19) United States
(12) Patent Application Publication
(10) Pub. No.: US 2010/0104676 A1
(43) Pub. Date: Apr. 29, 2010

(54) APPARATUS FOR COOLING TIRE AFTER VULCANIZATION

(75) Inventors: Hironobu Ichimaru, Fukuoka (JP); Naofumi Yoshimi, Fukuoka (JP)

Correspondence Address: DICKSTEIN SHAPIRO LLP, 1825 EYE STREET NW, Washington, DC, 20006-5403, US

(73) Assignee: HIROTEK CO., LTD., Chikugo-shi, Fukuoka (JP)

(21) Appl. No.: 12/525,507

(22) PCT Filed: Sep. 28, 2007
(86) PCT No.: PCT/JP2007/068982

§ 371 Date: Jul. 31, 2009

(30) Foreign Application Priority Data
Feb. 2, 2007 (JP) 2007-024305

(51) Int. Cl. B29C 35/16

(52) U.S. Cl. 425/40

(57) ABSTRACT

The invention aims to provide a vulcanized tire cooling apparatus configured to blow cooling air to a vulcanized tire in rotation, thereby achieving uniform cooling of the vulcanized tire and shortening of cooling time as well as preventing the vulcanized tire from being deformed due to centrifugal force. It includes a blower unit (4) set to blow air in a direction to the outer circumferential surface of a vulcanized tire (1) and a tire rotator (6) rotating the vulcanized tire supported with an upper rim (2) and a lower rim (3) in a circumferential direction. The apparatus is configured to cool down the vulcanized tire by blowing air to the outer circumferential surface thereof by the blower unit while the tire is rotated in the circumferential direction by the tire rotator.

### TECHNICAL FIELD

The present invention relates to a vulcanized tire cooling apparatus (PCI: post cure inflator) for use in a tire vulcanizer to cool a vulcanized tire which is molded through vulcanization.

### BACKGROUND ART

A tire vulcanizer is provided with a vulcanized tire cooling apparatus which cools down vulcanized tires which are molded through vulcanization. Such a vulcanized tire cooling apparatus is configured to supply air to inside of a vulcanized tire to pressurize the tire from the inside and maintain the tire shape as well as to support upper and lower bead portions of the vulcanized tire with an upper rim and a lower rim. In the prior art, the tire is cooled down by natural heat release while it is supported with the upper and lower rims.

There is a problem in this kind of cooling down by natural heat release that it needs a long cooling time. In view of solving such a problem, a vulcanized tire cooling apparatus which rotates a vulcanized tire to enforcedly cool it down by air force from the rotation has been proposed (see Patent Document 1).

This vulcanized tire cooling apparatus is configured to include a tire rotator which rotates a vulcanized tire in a circumferential direction while the upper and lower bead portions of the vulcanized tire are supported with the upper and lower rims, and to cool down the vulcanized tire by air force from the vulcanized tire rotated by the tire rotator.

However, in order to achieve sufficient cooling effects with the prior art vulcanized tire cooling apparatus which cools down the vulcanized tire by the air force from the rotation thereof, the vulcanized tire needs to be rotated at such a high speed as 100 rpm or more, or preferably 300 rpm or more. Such a high-speed rotation of the vulcanized tire causes a problem that a vulcanized tire as being soft and flexible through vulcanization is deformed and expanded outwards and cooled down as it remains deformed.

Patent Document 1: Japanese Unexamined Patent Application Publication No. 2006-137055.

### DISCLOSURE OF THE INVENTION

### Problem go be Solved by the Invention

An object of the present invention is to provide a vulcanized tire cooling apparatus which can evenly blow the entire outer circumferential surface of a vulcanized tire by rotating the vulcanized tire, to thereby achieve uniform cooling of the tire and shorten the cooling time, and prevent the vulcanized tire from being deformed due to centrifugal force unlike the prior art vulcanized tire cooling apparatus.

### Means to Solve the Problem

In view of solving the above problem, a vulcanized tire cooling apparatus according to the present invention cools down a vulcanized tire while the vulcanized tire is supported at an upper bead portion and a lower bead portion by an upper rim and a lower rim, and comprises a blower unit which is set to blow air in a direction to an outer circumferential surface of the vulcanized tire and a tire rotator which rotates, in a circumferential direction, the vulcanized tire being supported by an upper rim and a lower rim, wherein the vulcanized tire cooling apparatus is configured to cool down a vulcanized tire by blowing air onto the outer circumferential surface of the vulcanized tire by the blower unit while the vulcanized tire is rotated in a circumferential direction by the tire rotator.

Further, the vulcanized tire cooling apparatus according to the present invention is configured that the blower unit is a blower fan in the vulcanized tire cooling apparatus.

Further, the vulcanized tire cooling apparatus according to the present invention is configured that the blower unit is a blower tube with a nozzle hole to blow air to the outer circumferential surface of the vulcanized tire in the vulcanized tire cooling apparatus.

Further, the vulcanized tire cooling apparatus according to the present invention is configured that the blower unit is disposed in a single stage and/or a plurality of stages in a direction of a width of the vulcanized tire in the vulcanized tire cooling apparatus.

Further, the vulcanized tire cooling apparatus according to the present invention is configured to include a tubular hood which is disposed to surround an entire outer circumference of the vulcanized tire, wherein the blower unit is mounted on the tubular hood in the vulcanized tire cooling apparatus.

Further, the vulcanized tire cooling apparatus according to the present invention is configured that the blower unit is set to blow air in a direction which makes a certain angle with a radial line passing on a center of the vulcanized tire in the vulcanized tire cooling apparatus.

### ADVANTAGEOUS EFFECT OF THE INVENTION

The vulcanized tire cooling apparatus according to the present invention is configured that the blower unit blows air to the outer circumferential surface of a vulcanized tire while the tire rotator is rotating the vulcanized tire in a circumferential direction, to cool down the vulcanized tire.

Thus, since air is blown to the rotating vulcanized tire, it is possible to evenly blow air to the outer circumferential surface of the vulcanized tire. This can achieve uniform cooling of the tire and shorten the cooling time.

Further, unlike the prior art apparatus, it is not configured to cool down the vulcanized tire by air force from its rotation, thereby eliminating the necessity for rotating the vulcanized tire at high speed and preventing deformation of the vulcanized tire due to the centrifugal force.

Further, a blower fan or a blower tube with a nozzle hole can be used for the blower unit.

By use of the blower fan, the range in which the air is blown can be widened in comparison with the air blow from a nozzle hole of a ring-like blower tube, making it possible to avoid local blowing and reduce costs compared with the blower tube which ejects compressed air from the nozzle hole.

Further, the blower unit can be disposed in a single stage and/or a plurality of stages in a width direction of the vulcanized tire (vertical direction).

In particular, blower units disposed in the plural stages can evenly blow air to the vulcanized tire in the tire width direction including a tread portion, shoulder portions, and bead portion portions.

With the provision of the tubular hood which surrounds the entire outer circumference of the vulcanized tire, it is possible to block the air as a cooling medium blown by the blower unit to the outer circumferential surface of the vulcanized tire from outwardly flowing and to diffuse it in a space between the tubular hood and the outer circumferential surface of the vulcanized tire.

This creates a layer of air around the outer circumferential surface of the vulcanized tire and the air is evenly spread all over the outer circumferential surface thereof.

Accordingly, it is possible to achieve uniform cooling of the tire and shorten the cooling time.

Further, oily smoke occurs from the vulcanized tire due to the air blow and there is a problem of diffusion of the oily smoke.

The tubular hood can prevent the outward diffusion so that it is able to resolve such a problem that attachment of oily smoke to periphery elements or the like causes damages to the periphery elements or operational failures.

Thus, with the provision of the tubular hood, it is made possible to allow a layer of air occurring around the outer circumferential surface of the vulcanized tire to flow along the outer circumference of the vulcanized tire in a certain direction, when the blower unit is set to blow air in a direction which makes a certain angle with a radial line passing on a center of the vulcanized tire.

This makes it possible to more evenly spread the air all over the outer circumferential surface of the vulcanized tire.

### BEST MODE FOR CARRYING OUT THE INVENTION

FIG. 1 is a schematic plain view of a vulcanized tire cooling apparatus according to a first embodiment and FIG. 2 is a schematic cross-sectional view of the same.

In the drawings, a vulcanized tire 1 is to be cooled and it has been made of a green tire (raw tire) formed in a mold in a vulcanization process. Also, reference numerals 11, 12, 13, 14 represent an upper bead portion, a lower bead portion, a tread portion, shoulder portions, respectively.

The vulcanized tire cooling apparatus is configured to supply air to inside of the vulcanized tire 1 with an air supplier (now shown) to pressurize it from the inside and thereby maintain the shape of the tire, as well as to support the upper and lower bead portions 11, 12 with an upper rim 2 and a lower rim 3. The vulcanized tire 1 is subjected to a cooling processing in this supported state.

The first embodiment uses a plurality of axial flow blower fans 4 (hereinafter, blower fan) as a blower unit. Eight blower fans 4 in total, two arrays in a circumferential direction and four stages in a vertical direction (tire width direction), are mounted on a frame 5 which is provided on an outer circumference of the vulcanized tire 1.

The vulcanized tire cooling apparatus comprises a tire rotator 6 which rotates the vulcanized tire 1 in a circumferential direction (indicated by arrow D) while it is supported with the upper and lower rims 2, 3.

The tire rotator 6 comprises a lower cylinder 60 fixed on the lower rim 3, a locking shaft 70 rotatably supporting the lower cylinder 60, an upper cylinder 61 fixed on the upper rim 2, and a fixed cylinder 62 fixed on a casing 50 and rotatably supporting the upper cylinder 61. A belt 66 is extended over a pulley 63 of the upper cylinder 61 and a drive pulley 65 of an electric motor 64.

Accordingly, with the electric motor 64's being driven, the vulcanized tire 1 supported with the upper rim 2 and lower rim 3 can be rotated in the circumferential direction.

Here, the rotation speed thereof does not need to be a high speed, and a low rotation speed as 100 rpm or less, for example 30 rpm, 50 rpm, 80 rpm is sufficient.

Further, the fixed cylinder 62 contains a rotary inner tube 71 which is rotated by a not-shown rotary drive mechanism. The upper rim 2 and lower rim 3 are fixed by engaging a lock portion 72 of the rotary inner tube 71 and a lock portion 73 of a locking shaft 70.

Therefore, the blower fan 4 can cool down the vulcanized tire 1 by blowing air onto the outer circumferential surface thereof while the vulcanized tire 1 is rotated by the tire rotator 6 in the circumferential direction. It can evenly blow air to the entire outer circumferential surface of the vulcanized tire 1 since the vulcanized tire 1 is in rotation.

This can achieve uniform cooling of the tire and shorten the cooling time. Moreover, the vulcanized tire 1 need not be rotated at a high speed since it is not cooled down by air force from its own rotation. Therefore, it is able to prevent a problem of deforming the vulcanized tire 1 due to the centrifugal force.

Further, since the blower fans 4 are disposed in plural stages in the vertical direction (tire width direction), they can evenly blow air onto the entire vulcanized tire 1 in the tire width direction including the tread portion 13, shoulder portions 14, 14, bead portions 11, 12.

Next, FIG. 3 is a schematic cross-sectional view of a vulcanized tire cooling apparatus according to a second embodiment. The second embodiment uses, as the blower unit, a blower tube 8 having nozzle holes 80 from which air is blown to the outer circumferential surface of the vulcanized tire 1.

Here, it is configured that the blower tube 8 is mounted on the flame 5 on the outer circumference of the vulcanized tire 1, to extend in the vertical direction (tire width direction), and the blower tube 8 blows air to the outer circumferential surface of the vulcanized tire 1 through a large number of nozzle holes 80 thereof.

Note that the rest of structure and functions are the same as those of the first embodiment.

Next, FIG. 4 is a schematic plain view of a vulcanized tire cooling apparatus according to a third embodiment. In the third embodiment, a tubular hood 9 is disposed to surround the entire outer circumference of the vulcanized tire 1. The tubular hood 9 is configured to have the blower fan 4 (can be the blower tube) as the blower unit mounted thereon.

With provision of the tubular hood 9 as above, a ring-like space S is formed between the tubular hood 9 and the vulcanized tire 1.

The tubular hood 9 is a circular tube with a height to completely cover the height (tire width) of the vulcanized tire 1 and being concentric with the center C of the vulcanized tire 1.

The tubular hood 9 is made of two halved tubular members 9a, 9a whose one ends are turnably connected via a pin 9b and other ends are joined together and closed to become a circular tube at the pin 9 being the center. For replacement of the upper and lower rims 2, 3 or maintenance purpose, the tubular hood 9 is formed to be able to open/close by outwardly turning and releasing the halved tubular members 9a, 9a with the pin 9b as the center.

Note that a not-shown drive mechanism to open/close the halved tubular members 9a, 9a can be formed of an appropriate open/close mechanism, using an air cylinder, a hydraulic cylinder, an electric motor or the like as an actuator.

The plural blower fans 4 are set to blow air in a direction (indicated by arrow A) which makes a certain angle θ with a radial line R between the radial line R passing on the center C of the vulcanized tire 1 and a tangent line K to the outer circumference of the vulcanized tire 1.

This makes it possible to allow a layer of air occurring in the ring-like space S to flow along the outer circumference of the vulcanized tire 1 in a certain direction (indicated by arrow B).

Note that the angle θ can be arbitrarily set in accordance with the spacing of the ring-like space S and the air speed of the blower fan 4 or the like.

The air around the vulcanized tire 1 rise in whirls when the blower fan 4 is set to blow air in the direction (arrow A direction) and allows the layer of air to flow in the certain direction (arrow B direction) as above.

With provision of an oily smoke emission hood (not shown) over the tubular hood 9, oily smoke from the vulcanized tire 1 is prevented from spreading outwardly and at the same time flows in whirls into the oil smoke emission hood. In this manner, it is possible to smoothly evacuate the oily smoke without leak.

In the present invention, the blower fan or the blower tube and the nozzle holes as the blower unit are disposed in the circumferential direction and vertical direction. Since the vulcanized tire is rotated, it is preferable that the number of the fans or tubes is at least one in the circumferential direction and the number of stages is plural (can be singular) in the vertical direction.

Further, the direction in which the blower unit blow air can be set on the radial line, however, it is preferable to set the direction to make a certain angle with the radial line, with the advantage of the flowing layer of air taken into account.

### BRIEF DESCRIPTION OF THE DRAWINGS

FIG. 1 is a schematic plain view of a vulcanized tire cooling apparatus according to a first embodiment.

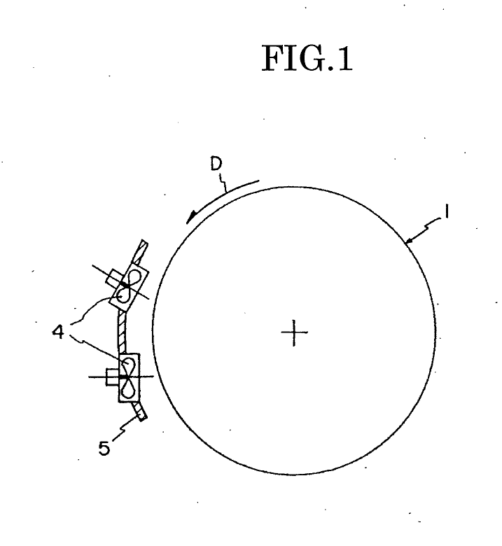

FIG. 2 is a schematic cross-sectional view of the vulcanized tire cooling apparatus.

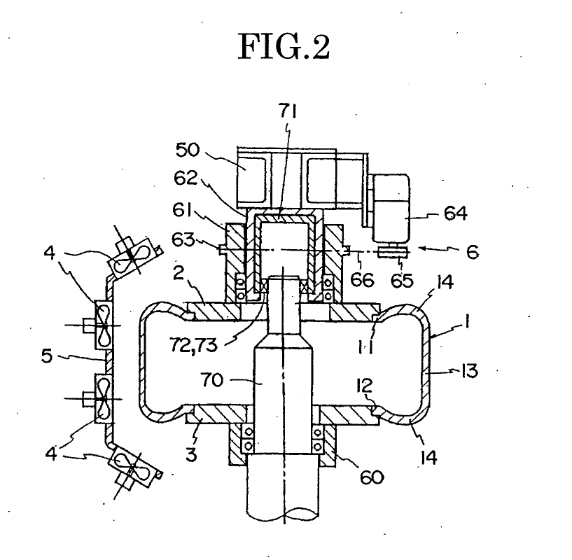

FIG. 3 is a schematic cross-sectional view of a vulcanized tire cooling apparatus according to a second embodiment.

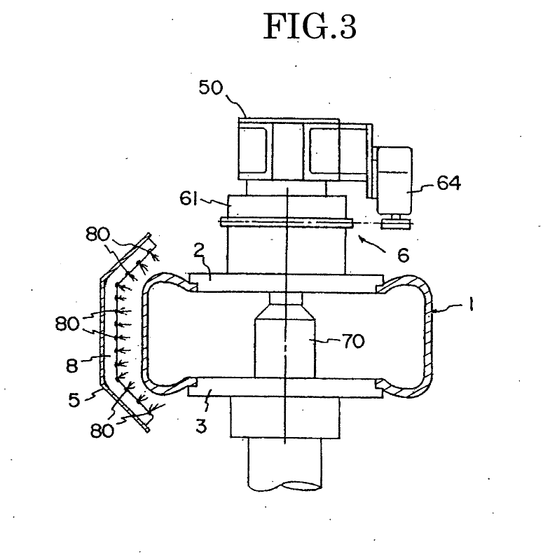

FIG. 4 is a schematic plain view of a vulcanized tire cooling apparatus according to a third embodiment.

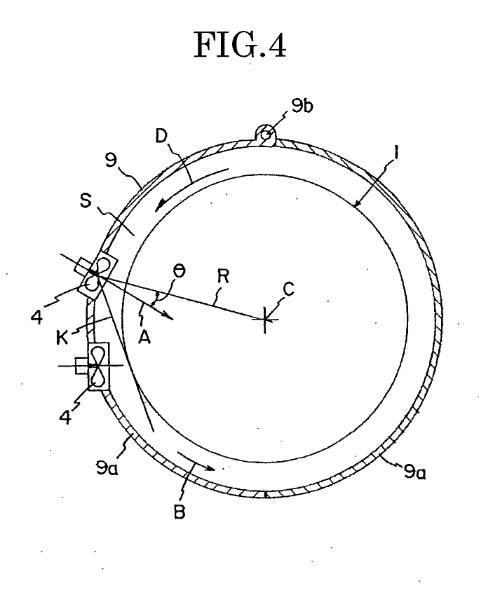

### DESCRIPTION OF NUMERIC CODES

1 vulcanized tire
11 upper bead portion
12 lower bead portion
13 tread portion
14 shoulder portion
2 upper rim
3 lower rim
4 axial flow blower fan (blower unit)
5 flame
50 casing
6 tire rotator
60 lower cylinder
61 upper cylinder
62 fixed cylinder
63 pulley
64 electric motor
65 drive pulley
66 belt
70 locking shaft
71 rotary inner tube
72 lock portion
73 lock portion
8 blower tube (blower unit)
80 nozzle hole (blower unit)
9 tubular hood
9a halved tubular member
9b pin
S ring-like space

1. A vulcanized tire cooling apparatus which cools down a vulcanized tire while the vulcanized tire is supported at an upper bead portion and a lower bead portion by an upper rim and a lower rim, comprising:
a blower unit which is set to blow air in a direction to an outer circumferential surface of the vulcanized tire; and
a tire rotator which rotates the vulcanized tire in a circumferential direction while the vulcanized tire is supported by an upper rim and a lower rim, wherein
the vulcanized tire cooling apparatus is configured to cool down a vulcanized tire by blowing air onto the outer circumferential surface of the vulcanized tire by the blower unit while the vulcanized tire is rotated in a circumferential direction by the tire rotator.

2. A vulcanized tire cooling apparatus according to claim 1, wherein the blower unit is a blower fan.

3. A vulcanized tire cooling apparatus according to claim 1, wherein
the blower unit is a blower tube with a nozzle hole to blow air to the outer circumferential surface of the vulcanized tire.

4. A vulcanized tire cooling apparatus according to claim 1, wherein
the blower unit is disposed in a single stage and/or a plurality of stages in a direction of a width of the vulcanized tire.

5. A vulcanized tire cooling apparatus according to claim 1, further comprising
a tubular hood which is disposed to surround an entire outer circumference of the vulcanized tire, wherein
the blower unit is mounted on the tubular hood.

6. A vulcanized tire cooling apparatus according to claim 5, wherein
the blower unit is set to blow air in a direction which makes a certain angle with a radial line passing on a center of the vulcanized tire.
